(19) United States
(12) Patent Application Publication
(10) Pub. No.: US 2014/0320848 A1
(43) Pub. Date: Oct. 30, 2014

(54) APPARATUS FOR DETECTING CRYSTALLIZING STAIN

(71) Applicant: Samsung Display Co., Ltd., Yongin-City (KR)

(72) Inventors: Ki-Young YEON, Yongin-City (KR); Nari AHN, Yongin-City (KR)

(73) Assignee: Samsung Display Co., Ltd., Yongin-City (KR)

(21) Appl. No.: 13/973,533

(22) Filed: Aug. 22, 2013

(30) Foreign Application Priority Data
Apr. 29, 2013 (KR) 10-2013-0047561

(51) Int. Cl. G01N 21/95; G01N 21/88

(52) U.S. Cl. CPC G01N 21/9501; G01N 21/8806
USPC 356/51; 356/364

(57) ABSTRACT

An apparatus for detecting a crystallizing stain includes a support unit, a crystallized substrate disposed on the support unit, a light source which irradiates polarized light in a predetermined wavelength range to a portion of the crystallized substrate, and a detector which detects the crystallizing stain in the portion of the crystallized substrate, to which the polarized light is irradiated.

This application claims priority to Korean Patent Application No. 10-2013-0047561 filed on Apr. 29, 2013, and all the benefits accruing therefrom under 35 U.S.C. §119, the content of which in its entirety is herein incorporated by reference.

### BACKGROUND

(a) Field

The disclosure relates to an apparatus for detecting a crystallizing stain.

(b) Description of the Related Art

In general, amorphous silicon (“a-Si”) typically has a low mobility of an electron a charge carrier and a low opening ratio and may not be effectively used for a complementary metal-oxide-semiconductor (“CMOS”) process. In a poly-silicon (“Poly-Si”) thin film device, unlike an a-Si thin film transistor (“TFT”), a driving circuit necessary to write an image signal in a pixel is provided on a substrate such as a pixel TFT-array. Accordingly, in the poly-Si thin film device, where connection between a plurality of terminals and a driver integrated circuit (“IC”) is unnecessary, productivity and reliability may be increased and a thickness of a panel may be reduced.

The poly-Si TFT may be manufactured under a high temperature condition or under a low temperature condition. In a process where the poly-Si TFT is manufactured under the high temperature condition, the substrate having a large area may not be efficiently manufactured since the substrate made of a material at a high cost, such as quartz, is used in such a process. Accordingly, research into a method of mass-producing an a-Si by a poly-Si under the low temperature condition has been actively performed. Examples of a method of forming a poly-silicon under the low temperature include a solid phase crystallization (“SPC”), a metal induced crystallization (“MIC”), a metal induced lateral crystallization (“MILCM”), and an excimer laser annealing (“ELA”).

In a method of forming a poly-silicon under the low temperature, a laser crystallization device such as the ELA typically crystallizes a target thin film by an excimer laser.

In such a method, due to a limited size of a cross-section of a laser crystallization device, a plurality of crystallizing stains may occur when the laser crystallization device is applied to crystallize a large-sized display device.

### SUMMARY

Exemplary embodiments of the invention relate to an apparatus for detecting a crystallizing stain, which detects various types of crystallizing stains based on optical characteristics with increased detection ability.

An exemplary embodiment of the invention provides an apparatus for detecting a crystallizing stain, including: a support unit; a crystallized substrate disposed on the support unit; a light source which irradiates polarized light in a predetermined wavelength range to a portion of the crystallized substrate; and a detector which detects the crystallizing stain in the portion of the crystallized substrate, to which the polarized light is irradiated.

In an exemplary embodiment, the polarized light in the predetermined wavelength range may include a sigma-polarized light in the predetermined wavelength range and pi-polarized light in the predetermined wavelength range, and transmittance of the sigma-polarized light in the predetermined wavelength range through the crystallized substrate may be substantially different from transmittance of the pi-polarized light in the predetermined wavelength range through the crystallized substrate.

In an exemplary embodiment, the wavelength section may include at least one of a wavelength range of about 435 nanometer (nm) to about 465 nm, a wavelength range of about 500 nm to about 530 nm or a wavelength range of about 715 nm to about 730 nm.

In an exemplary embodiment, an angle of a line between the portion of the crystallized substrate and the light source unit with respect to the crystallized substrate may be in a range of about 40° to about 60°.

In an exemplary embodiment, an angle of a line between the portion of the crystallized substrate and the detector with respect to the crystallized substrate may be in a range of about 40° to about 70°.

In an exemplary embodiment, the light source may include a light emitting diode (“LED”) light source.

In an exemplary embodiment, the light source unit may include at least one of a polarizing plate and a half-wave plate (λ/2), and the at least one of the polarizing plate and the half-wave plate may control a polarized degree of each wavelength of light emitted from the LED light source.

In an exemplary embodiment, the light source may include a plurality of LEDs.

In an exemplary embodiment, the light source may include a laser.

In an exemplary embodiment, the laser may include a dual beam laser.

In an exemplary embodiment, the light source may include an optical parametric amplifier (“OPA”), an optical parametric oscillator (“OPO”), and an optical parametric generator (“OPG”).

In an exemplary embodiment, the light source unit may include a shortwave length laser.

In exemplary embodiments, the apparatus for detecting a crystallizing stain detects various types of crystallizing stains based on optical characteristics thereof with increased detection ability.

### BRIEF DESCRIPTION OF THE DRAWINGS

The above and other features of the invention will become more apparent by describing in further detail exemplary embodiments thereof with reference to the accompanying drawings, in which:

FIG. 1 is a block diagram illustrating an exemplary embodiment of an apparatus for detecting a crystallizing stain.

FIG. 2 is a graph of transmittance difference according to polarization of incident light (percentage: %) versus wavelength (nanometer: nm), illustrating an experimental value with respect to a transmittance difference as a function of wavelength according to an exemplary embodiment.

FIG. 3 is a graph of normalized power versus wavelength (nm), illustrating a theoretical value with respect to reflection, transmission and scattering spectra at each wavelength of sigma-polarized (“S-polarized”) incident light according to an exemplary embodiment.

FIG. 4 is a graph of normalized power versus wavelength (nm), illustrating a theoretical value with respect to reflection, transmission and scattering spectra at each wavelength of pi-polarized (“P-polarized”) incident light according to an exemplary embodiment.

FIG. 5 is a graph of transmittance difference according to polarization of incident light (%) versus wavelength (nm), illustrating a theoretical value with respect to a transmission spectrum between FIG. 3 and FIG. 4.

FIG. 6 is a schematic diagram illustrating an exemplary embodiment of a light source unit.

FIG. 7 is a plan view of the light source shown in FIG. 6.

FIG. 8 is a block diagram illustrating an alternative exemplary embodiment of a light source unit.

FIG. 9 is a schematic diagram illustrating an exemplary embodiment of a light source unit.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on,” “connected to” or “coupled to” another element or layer, the element or layer can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

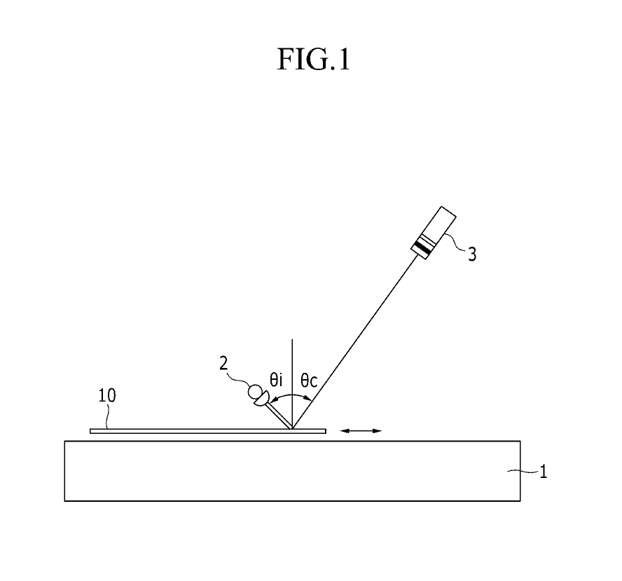

Hereinafter, an exemplary embodiment of an apparatus for detecting a crystallizing stain will be described with reference to FIG. 1.

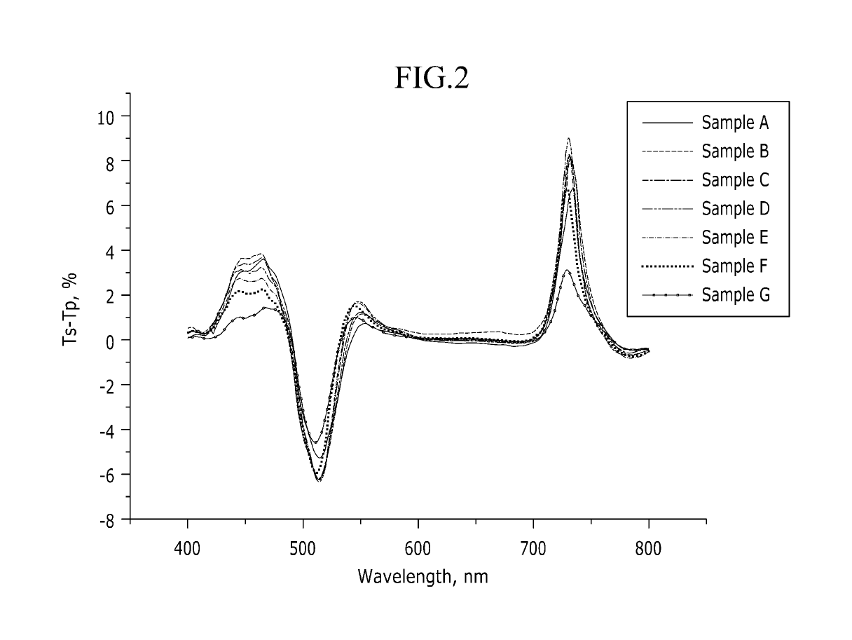

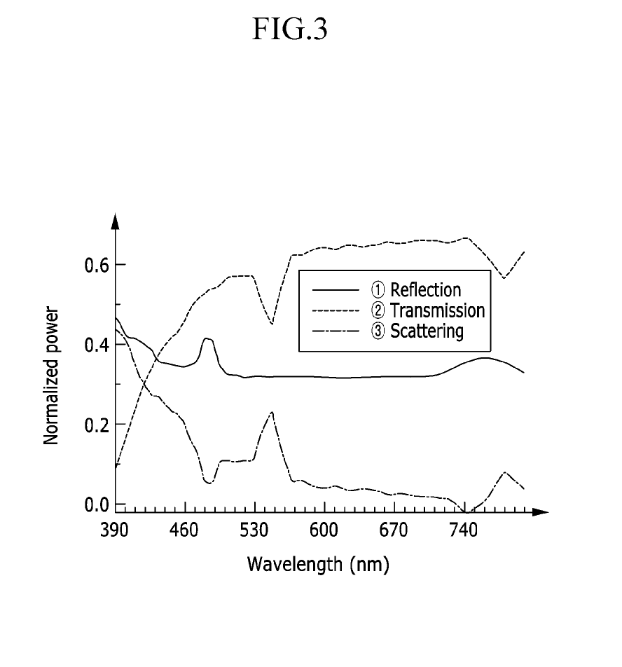

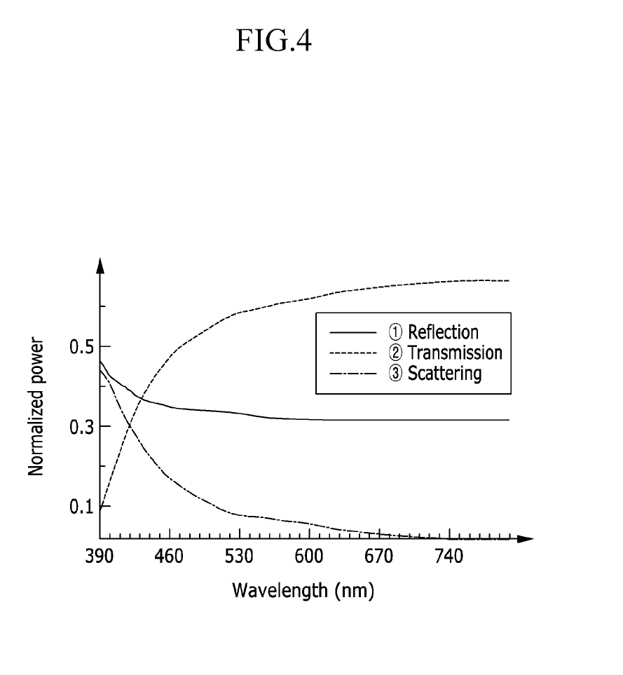

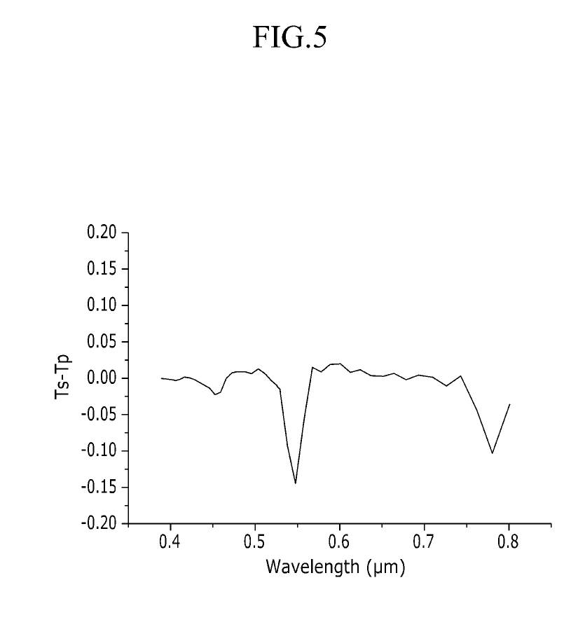

FIG. 1 is a block diagram illustrating an exemplary embodiment of an apparatus for detecting a crystallizing stain. FIG. 2 is a graph of transmittance difference according to polarization of incident light (percentage: %) versus wavelength (nanometer: nm) illustrating an experimental value of the transmittance as a function of wavelength according to an exemplary embodiment. FIG. 3 is a graph of normalized power versus wavelength (nm), illustrating a theoretical value with respect to reflection, transmission and scattering spectra at each wavelength of sigma-polarized (“S-polarized”) incident light according to an exemplary embodiment. FIG. 4 is a graph of normalized power versus wavelength (nm), illustrating a theoretical value with respect to reflection, transmission and scattering spectra at each wavelength of pi-polarized (“P-polarized”) incident light according to an exemplary embodiment. FIG. 5 is a graph of transmittance difference according to polarization of incident light (%) versus wavelength (nm), illustrating a theoretical value with respect to a transmission spectrum between FIG. 3 and FIG. 4.

In an exemplary embodiment, the apparatus for detecting a crystallizing stain may detect the crystallizing stain having various shapes and improve a matching characteristic.

Referring to FIG. 1, an exemplary embodiment of the apparatus for detecting a crystallizing stain may include a support unit 1, a light source unit 2 and a detector 3.

In such an embodiment, the support unit 1 supports a crystallized substrate 10 disposed, e.g., mounted, thereon.

In one exemplary embodiment, as shown in FIG. 1, the support unit 1 may include a frame with a cross-sectional area having rectangular shape, but is not limited thereto.

The light source unit 2 is disposed, e.g., installed, above the substrate 10 on the support unit 1 and irradiates light to the substrate 10.

In such an embodiment, the light source unit 2 improves detecting ability when the detector 3 detects defects from a surface of the substrate 10.

In an exemplary embodiment, the light source unit 2 irradiates polarized light in a predetermined wavelength range.

In such an embodiment, where the light source unit 2 irradiates polarized light in the predetermined wavelength range, measuring sensitivity is increased, and the detection ability is substantially improved.

Referring to FIG. 2, a graph of a transmittance difference according to polarization of incident light versus wavelength is illustrated.

The graph shows a result of an experiment performed by measuring transmittance by irradiating polarized light at each wavelength in a wavelength range with respect to various samples, e.g., samples A to G, having different surface structures.

In the graph of FIG. 2, a vertical axis of the graph illustrates a transmittance difference (hereinafter, “Ts−Tp value”), where Ts denotes transmittance when the polarized light is incident substantially parallel to a surface of a sample, and Tp denotes transmittance when the polarized light is incident substantially perpendicular to the surface of the sample.

In the graph of FIG. 2, when an absolute value of the Ts−Tp value is increased, a detection effect is increased.

Referring to FIG. 2, the absolute value of the Ts−Tp value is maximized in the vicinity of about 450 nanometers (nm), about 515 nm, or about 730 nm, which is a peak value.

Referring further to FIG. 2, the Ts−Tp values of samples A to G may not be substantially changed through the entire of the wavelength range.

However, in FIG. 2, there is a difference of the absolute value of the Ts−Tp value in the vicinity of about 450 nm, 515 nm, and 730 nm according to some of the samples. As shown in FIG. 2, in an exemplary embodiment, the light source unit 2 irradiates polarized light in the predetermined wavelength range including the wavelength of about 450 nm, about 515 nm, or about 730 nm, various types of failures may be detected for various samples, e.g., samples A to G, having different surface structures.

In addition, FIGS. 3 and 4 illustrate graphs of normalized power versus wavelength showing theoretically calculating reflection, transmission and scattering degrees according to S-polarized incident light and P-polarized incident light at each wavelength, respectively.

In addition, FIG. 5 illustrates a graph of a transmittance difference versus wavelength between the S-polarized incident light and the P-polarized incident light of FIG. 3 and FIG. 4.

Referring to FIGS. 3 to 5, since a variation degree of the difference between the S-polarized incident light and the P-polarized incident light is increased in only a predetermined wavelength range, as in the graph show in FIG. 2.

Experimental data and theoretical data illustrated in FIGS. 2 to 5 show variation according to polarization, e.g., variation degree of the difference between the S-polarized incident light and the P-polarized incident light, when a defect such as a crystallizing stain of several tens of nanometers remains on a surface of the substrate 10. As described above and shown in FIGS. 2 to 5, based on a substantial difference with respect to transmittance of light in a predetermined wavelength range, an exemplary embodiment uses light having a wavelength range including the predetermined wavelength range, such that detection sensitivity is substantially improved.

Accordingly, an exemplary embodiment of the light source unit 2 irradiates polarized light in a predetermined wavelength range including a wavelength range of about 435 nm to about 465 nm, a wavelength range of about 500 nm to about 530 nm or a wavelength range of about 715 nm to about 730 nm based on the experiment and theoretical calculation described above.

Referring back to FIGS. 3 and 4, a theoretical calculation is achieved through reflection and transmission spectra as follows. In such a theoretical calculation, an angle between a light source irradiated from the light source and a normal line perpendicular to the substrate 10 (e.g., incident angle, θi in FIG. 2) is set to be in a range of about 30° to about 50°.

Accordingly, in an exemplary embodiment, the light source unit 2 may be disposed in a predetermined position such that the light from the light source unit 2 is irradiated to the substrate 10 at an angle in a range of about 40° to about 60° with respect to the substrate 10.

In such a theoretical calculation, an angle between a light source reflected from the substrate 10 and a normal line perpendicular to the substrate 10 (reflection angle, θc in FIG. 1) is set to be in a range of about 20° to about 50°.

Accordingly, in an exemplary embodiment, an angle between the detector 3 and the substrate 10, e.g., an angle of a line from the detector 3 to a portion of the substrate 10 with respect to the surface of the substrate 10, may be in a range of about 40° to about 70°.

In an exemplary embodiment, the light source unit 2 may include a light emitting diode (“LED”) light source or a laser. An exemplary embodiment of the light source unit 2 will be described later in greater detail.

In such an embodiment, the detector 3 is installed at an opposite side of the light source unit 2 with respect to an imaginary line perpendicular to the support unit 1.

In an exemplary embodiment, the detector 3 detects defects such as a crystallizing stain in a region of the substrate 10, to which the light from the light source unit 2 is irradiated.

Referring back to FIG. 1, the detector 3 may be disposed substantially symmetrical to the light source unit 2 with respect to an imaginary line perpendicular to the support unit 1.

In an exemplary embodiment, the detector 3 measures transmittance of S-polarized incident light Ts, e.g., transmittance of incident light that is polarized substantially parallel to a sample surface, and transmittance of P-polarized incident light Tp, e.g., transmittance of incident light that is polarized substantially perpendicular to the sample surface, as described above. By comparing a spectrum of the transmittance of S-polarized incident light Ts at a predetermined wavelength range with a spectrum of the transmittance of P-polarized incident light Tp at the predetermined wavelength range, the reaction sensitivity of a specific structure in the sample, e.g., a nano structure or a defect such as the crystallizing stain, is substantially improved. Accordingly, in such an embodiment, the defect is substantially effectively detected with improved visibility.

As described above, an exemplary embodiment of the detector 3 may receive the light reflected from a portion of the substrate 10 at an angle (e.g., reflection angle, θc) in a range of about 20° to about 50°, and the angle of a line between the detector 3 and the portion of the substrate 10 with respect to the substrate 10 may be in a range of about 40° to about 70°.

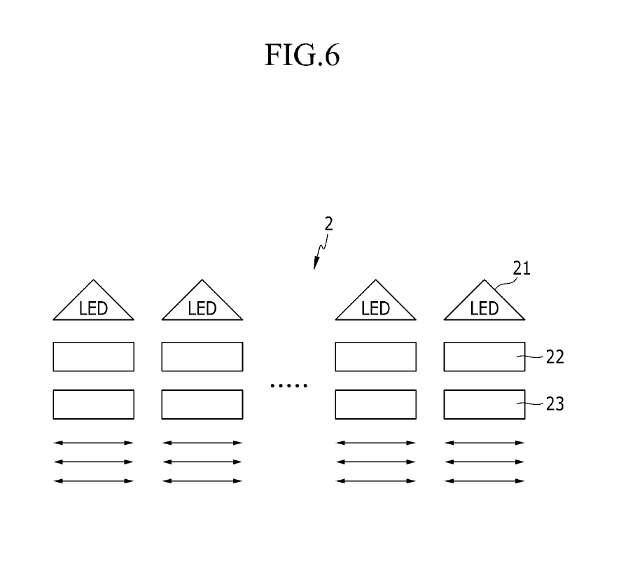

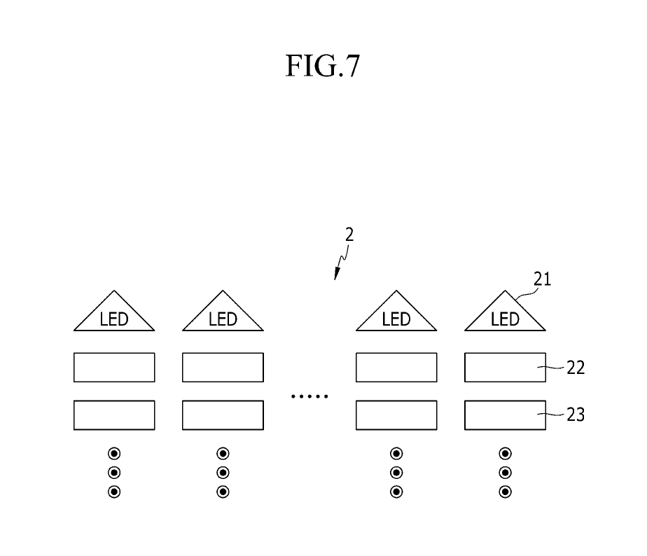

Hereinafter, exemplary embodiments where the light source of the light source includes an LED light source or a laser will be described in detail with reference to FIG. 6 and FIG. 7.

FIG. 6 is a schematic diagram illustrating an exemplary embodiment of a light source unit. FIG. 7 is a plan view of the light source unit shown in FIG. 6.

Referring to FIG. 6, an exemplary embodiment of a light source unit 2 may include an LED light source 21, a polarizing plate 22 and a half-wave plate 23.

In such an embodiment, when light radiated from the LED light source 21 passes through the polarizing plate 22, the polarization of the light radiated from the LED light source 21 is changed such that light polarized at a specific polarization degree is obtained.

In an exemplary embodiment, the LED light source 21 emits the light in a wavelength range, a center of which is substantially close to a wavelength of about 450 nm, about 515 nm or about 730 nm.

In such an embodiment, when the light passed through the polarizing plate 22 passes through the half-wave plate 23, as shown in FIG. 7, a polarized direction may be rotated at an angle of the half-wave plate 23.

In FIGS. 6 and 7, an arrow ( [symbol] ) and a circle (⊙) represent polarization direction of the polarized light, respectively. The arrow in FIG. 6 represents polarization of about zero degree (0°), and the arrow is rotated at an angle of about 90° as shown by the circle in a plan view of FIG. 7.

In an exemplary embodiment, as shown in FIGS. 6 and 7, the light source unit 2 may include a plurality of LED light sources 21, a plurality of polarizing plates 22 and a plurality of half-wave plates 23, such that the light source unit 2 may provide the light for measurement to a substantially wide area on the substrate 10 at the same time, and a measuring time is thereby substantially reduced.

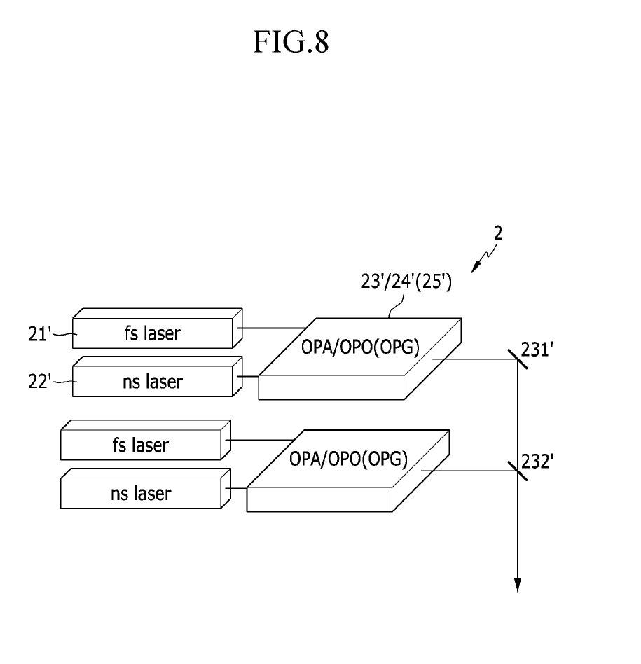

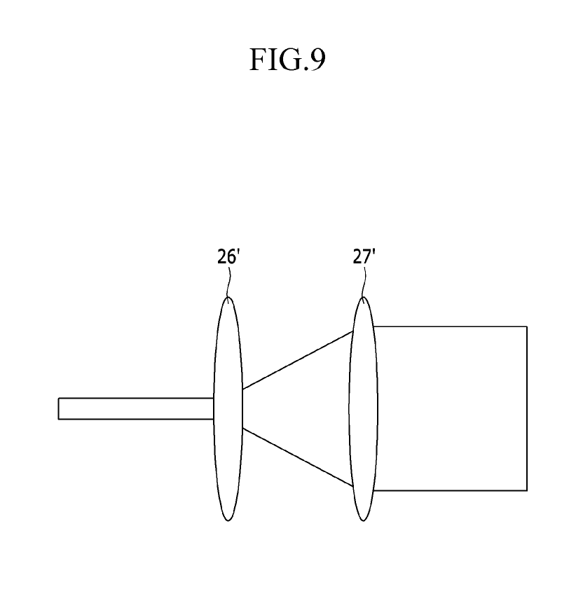

FIG. 8 is a block diagram illustrating an alternative exemplary embodiment of a light source unit. FIG. 9 is a schematic diagram illustrating an exemplary embodiment of a light source.

Referring to FIG. 8, an exemplary embodiment of a light source unit 2 may include a plurality of lasers, e.g., a first laser 21′ and a second laser 22′, and optical parametric amplifier (“OPA”)/optical parametric oscillator (“OPO”) 23′/24′. In an alternative exemplary embodiment, the OPA/OPO 23′/24′ may further include optical parametric generator (“OPG”) 25′.

In an exemplary embodiment, where the light source unit 2 includes an LED light source, as described above, the light source unit may emit light having a predetermined wavelength. In an exemplary embodiment, where the light source unit 2 includes a plurality of lasers, e.g., the first and second lasers 21′ and 22′, the light source unit 2 may emit light having a wavelength range of about 200 nm to about 1,064 nm.

In an exemplary embodiment, as shown in FIG. 8, the OPA/OPO(OPG) 23′/24′(25′) may change the wavelength of the light generated from the first and second lasers 21′ and 22′, and may be configured separately from the first and second lasers 21′ and 22′. In an exemplary embodiment, the OPA/OPO(OPG) 23724′(25′) may be disposed, e.g., embedded, in the first and second lasers 21′ and 22′.

In an exemplary embodiment, as shown in FIG. 8, the first and second lasers 21′ and 22′ may include a femtosecond (“fs”) laser and a nanosecond (“ns”) laser, respectively, and the wavelength of the light generated therefrom may be changed by the OPA/OPO(OPG) 23′/24′(25′), but not being limited thereto. In an alternative exemplary embodiment, the first and second lasers 21′ and 22′ may include a plurality of shortwave lasers having a predetermined wavelength, or a dye laser, the wavelength of which may be selected.

In an exemplary embodiment of the light source unit 2′, where the first and the second laser 21′ and 22′ include the femtosecond (fs) laser and the nanosecond (ns) laser, respectively, reaction between the light source unit 2 and the substrate 10 may be observed in a time-resolved scheme.

In such an embodiment, where the light source unit 2 includes a laser, the size and intensity of a beam output from the laser may be limited to a predetermined size and intensity.

In an alternative exemplary embodiment, as shown in FIG. 9, the light source unit 2 may further include a plurality of lenses, e.g., first and second lenses 26′ and 27′. In such an embodiment, the size of the beam may be enlarged through a combination of the first and second lenses 26′ and 27′ such that the laser applied to the substrate 10 has a large area.

In such an embodiment, where the size of the beam is enlarged, the number of photons per unit area, that is, optical density may be reduced.

In an alternative exemplary embodiment, the light source unit 2 may include a multi-beam laser, e.g., a dual beam laser as shown in FIG. 8, such that the number of photons per unit area of the substrate 10 may be increased.

In such an embodiment, where the light source unit 2 includes a dual beam laser as shown in FIG. 8, a beam radiated through a plurality of first laser 21′ and a plurality of second lasers 22′ passes through the OPA/OPO(OPG) 23′/24′(25′) and is changed to a predetermined wavelength, and passes through first and second mirror 231′ and 232′.

In such an embodiment, the first and second mirrors 231′ and 232′ are a typical mirror. Beams passing through the first mirror 231′ and the second mirror 232′ may have paths in a same direction, but is not limited thereto. In an exemplary embodiment, a direction of the beam passing through the first mirror 231′ may be variously modified not to pass through the second mirror 232′ and not to affect the second mirror 232′.

Accordingly, in an exemplary embodiment, the light source unit 2 may include a dual beam laser and lenses, the size of the beam may be effectively increased without reducing the optical density thereof.

As mentioned above, exemplary embodiments of the invention are disclosed herein, but the invention is not limited to the disclosed embodiments, but, on the contrary, is intended to cover various modifications and equivalent arrangements included within the appended claims and the detailed description and the accompanying drawing of the invention.

What is claimed is:

1. An apparatus for detecting a crystallizing stain, the apparatus comprising:
a support unit;
a crystallized substrate disposed on the support unit;
a light source which irradiates polarized light in a predetermined wavelength range to a portion of the crystallized substrate; and
a detector which detects the crystallizing stain in the portion of the crystallized substrate, to which the polarized light is irradiated.

2. The apparatus of claim 1, wherein
the polarized light in the predetermined wavelength range comprises a sigma-polarized light in the predetermined wavelength range and pi-polarized light in the predetermined wavelength range, and
transmittance of the sigma-polarized light in the predetermined wavelength range through the crystallized substrate is substantially different from transmittance of the pi-polarized light in the predetermined wavelength range through the crystallized substrate.

3. The apparatus of claim 2, wherein the predetermined wavelength range comprises at least one of a wavelength range of about 435 nm to about 465 nm, a wavelength range of about 500 nm to about 530 nm and a wavelength range of about 715 nm to about 730 nm.

4. The apparatus of claim 1, wherein an angle of a line between the portion of the crystallized substrate and the light source unit with respect to the crystallized substrate is in a range of about 40° to about 60°.

5. The apparatus of claim 1, wherein an angle of a line between the portion of the crystallized substrate and the detector with respect to the crystallized substrate is in a range of about 40° to about 70°.

6. The apparatus of claim 1, wherein the light source comprises a light emitting diode light source.

7. The apparatus of claim 6, wherein
the light source unit comprises at least one of a polarizing plate and a half-wave plate, and
the at least one of the polarizing plate and the half-wave plate controls a polarized degree of each wavelength of light emitted from the light emitting diode light source.

8. The apparatus of claim 7, wherein the light emitting diode light source comprises a plurality of light emitting diodes.

9. The apparatus of claim 1, wherein the light source comprises a laser.

10. The apparatus of claim 9, wherein the laser comprises a dual beam laser.

11. The apparatus of claim 9, wherein the light source comprises an optical parametric amplifier, an optical parametric oscillator and an optical parametric generator.

12. The apparatus of claim 9, wherein the light source unit comprises a shortwave laser.
